(19) United States
(12) Patent Application Publication
(10) Pub. No.: US 2019/0143533 A1
(43) Pub. Date: May 16, 2019

(54) GRIPPING TONGS

(71) Applicant: FIPA Holding GmbH, Ismaning (DE)

(72) Inventors: Henning Schanz, Gilching (DE); Niels Blomeyer, Starnberg (DE)

(21) Appl. No.: 16/183,199

(22) Filed: Nov. 7, 2018

(30) Foreign Application Priority Data
Nov. 13, 2017 (DE) 10 2017 126 564.3

(51) Int. Cl. B25J 15/00

(52) U.S. Cl. CPC B25J 15/0023

(57) ABSTRACT

The present invention relates to gripping tongs, particularly pneumatically operated gripping tongs. The gripping tongs comprise a housing in which a preferably pneumatically operable linear drive is formed. A first and a second gripper jaw movable relative to each other and relative to the housing, in particular pivotably mounted, are further provided. To be able to detect whether a workpiece (object to be gripped) has been effectively gripped, particularly in the case of miniature gripping tongs of this type, the invention provides for one of the two gripper jaws of the gripping tongs to itself be designed as a sensor and thereby serve to emit a corresponding signal when the gripper jaws of the gripping tongs have gripped a workpiece and/or when the gripping tongs are in their closed state.

### RELATED APPLICATIONS

The present application claims priority from German Patent Application No. 10 2017 126 564.3 filed Nov. 13, 2017, which is incorporated herein by reference in its entirety for all purposes.

### DESCRIPTION

The present invention relates to gripping tongs in accordance with the preamble of independent claim 1.

Accordingly, the invention relates in particular to gripping tongs, particularly pneumatically operated gripping tongs, wherein the gripping tongs comprise a housing in which a preferably pneumatically operable linear drive is formed. The gripping tongs further comprise a first and second gripper jaw, which are each pivotably mounted about an axis of rotation relative to the housing. Preferably, the first gripper jaw and the second gripper jaw are coupled to the linear drive such that a linear motion generated by the linear drive is converted into a pivoting motion of the respective first and second gripper jaw in an opening or closing direction of the gripper jaws.

Such gripping tongs are frequently used in conjunction with industrial robots for handling different objects/parts/workpieces. Such gripping tongs usually comprise at least two pincer-like gripper jaws which are pivotable or linearly displaceable longitudinally relative to one another along suitable guides and grasp and grip an object to be gripped, or a part/workpiece to be gripped respectively, from opposite sides by way of facing gripping surfaces.

So that the object and/or the part/workpiece is on the one hand held securely between the gripper jaws and on the other hand not damaged when being gripped, maximum reliability of the gripping tongs is essential.

On the other hand, such gripping tongs, which are occasionally also called “grippers,” should have the most compact possible design and lowest possible weight in relation to a high gripping force, so that they can be used in widely diverse applications, including particularly in robotics as a robotic gripping tool.

Such gripping tongs thus fulfill the function of grasping and holding and form the connection between a robotic arm and the workpiece. The decisive factors for secure contact are thereby the type of interaction and the number of contact planes. Interaction can be achieved by force, form or material mating. When employing force mating, the grip is produced by pressure being exerted on the workpiece surface. In contrast thereto, the grip in form mating results from a similarly shaped encircling of the workpiece. These methods have to date only been used to a limited extent in industry, whereby, however, change is on the horizon, particularly in microassembly.

Gripping tongs in the sense of the present invention describe the working member of a robot. This includes actuators/effectors, but also the required auxiliary equipment such as wrist axes, switching systems, jointing aids, protective devices and sensor units.

In order to optimize the reliability of gripping tongs, it is common to provide them with sensors with which the correct position and presence of a workpiece can be determined or detected, the precise processing of the workpiece can be controlled, or the corresponding processing parameters can be checked.

Thus, gripping tongs of the above-cited type are known for example from printed publication DE 10 2014 211 772 A1, wherein a sensor is assigned to said gripping tongs, said sensor being disposed on a gripper jaw body of a first gripper jaw such that it can be triggered by a gripper jaw element of the first gripper jaw. Said sensor arrangement on one of the two gripper jaws of the gripping tongs makes it possible for a workpiece (object to be gripped) to be gripped by the gripping tongs and for the gripping to activate the sensor. In so doing, it can be detected whether the object to be gripped has been gripped.

However, this known prior art sensor technology provided on one of the two gripper jaws of gripping tongs is not applicable in the case of miniature gripping tongs due to the small size of the gripper jaws used therein such that these types of miniature gripping tongs have to date been furnished without corresponding sensor technology.

The present invention is based on the task of specifying a solution in which gripping by the gripper jaws can also be effectively detected in the case of miniature gripping tongs.

The invention solves this task by at least one of the two gripper jaws of the gripping tongs itself being designed as a sensor and serving to emit a corresponding signal when the gripper jaws of the gripping tongs have gripped a work-piece (object to be gripped) and/or when the gripping tongs are in their closed state. In other words, in place of a sensor device arranged on one of the two gripper jaws of the gripping tongs as in previous prior art, the invention provides for at least one of the two gripper jaws itself to be designed as a corresponding sensor such that the gripper jaw(s) fulfills a dual function: On the one hand, the gripper jaws serve to grip the object to be gripped while, on the other hand, the gripping is in addition detected by the at least one gripper jaw itself.

The designing of the at least one gripper jaw as a sensor can be realized in various ways. It is for example conceivable for a resonating electrical circuit (oscillator) with a coil to be integrated into the first gripper jaw designed as a sensor, whereby the resonating electrical circuit is designed to vibrate when a supply voltage is applied and generate an electromagnetic field. Preferably, the resonating electrical circuit thereby comprises a ferrite core or the like in which the coil is situated in order to direct the electromagnetic field generated by the oscillator to a gripping area between the first and the second gripper jaw.

In conjunction thereto, it is advantageous for at least part of the second gripper jaw of the gripping tongs to be formed from an electrically conductive material, particularly metallic material, whereby the electrically conductive and particularly metallic material is preferably provided in an area of the second gripper jaw adjoining the gripping area of the gripping tongs.

By detecting an influencing of the oscillator voltage, it is thus possible to conclude a position of the gripper jaws relative to each other. In one conceivable realization, a corresponding evaluation unit is therefore further provided which is designed to detect an influencing of the oscillator voltage and emit a signal based on that which is indicative of a position of the gripper jaws relative to each other.

As soon as a supply voltage is applied to the oscillator integrated into the first gripper jaw, the oscillator begins to vibrate. The electromagnetic field thereby developing is preferably directed forward toward the active area of the first grip-ping jaw adjoining the gripping area of the gripping tongs by means of the ferrite core, in which the coil of the oscillator's resonant circuit is situated. As the second gripper jaw then approaches the first gripper jaw, energy is drawn from the resonant circuit, whereupon the oscillator voltage decreases. An optional downstream comparator detects the reduction in oscillator voltage and controls an output circuit amplifier at the set operating interval or oscillation level.

Alternatively or additionally to the inductive sensor system integrated into the gripper jaws of the gripping tongs, it is conceivable for the first gripper jaw of the gripping tongs to be designed as a measuring electrode and the second gripper jaw of the gripping tongs as a counter electrode, wherein the two gripper jaws together form an electrical capacitor. The capacitance or respectively change in capacitance of the electrical capacitor designed as such is detected by means of an evaluation unit, this in turn enabling a conclusion as to the position of the gripper jaws relative to each other in addition to a conclusion as to a workpiece (object to be gripped) gripped between the gripper jaws. This system is based on the knowledge that the capacitance of the electrical capacitor formed by virtue of the measuring electrode and the counter electrode changes when an object to be gripped is brought into the gripping area of the gripping tongs. On the other hand, a change in capacitance also occurs upon a change in the position of the two gripper jaws relative to each other.

In this context, it is also conceivable for so-called shield electrodes to be formed in the first gripper jaw in order to shield an inhomogeneous peripheral area of the electrical field from the measuring electrode so that a nearly parallel electrical field with the known characteristics of an ideal plate capacitor forms between the first gripper jaw serving as the measuring electrode and the e.g. electrically grounded second gripper jaw designed as a counter electrode. This thereby enables the better detecting of small changes in capacitance.

The gripper jaws of the gripping tongs are preferably designed both as inductive as well as capacitive sensors in order to be able to detect the position of the gripper jaws relative to each other and a workpiece grasped by the gripper jaws irrespective of the material of the workpiece (object to be gripped).

The inventive solution is not limited to the inductive and/or capacitive measuring devices described above. On the contrary, it is conceivable for at least one area of the first gripper jaw and/or second gripper jaw to be designed as a resistive sensor area, inductive sensor area, magnetic field sensor area, capacitive sensor area and/or piezoelectric sensor area.

The functional principle behind a resistive sensor area is that of the ohmic resistance of the gripper jaw designed as a sensor changing as a function of a measured variable (length, temperature, etc.). This change in resistance leads to a changed drop in voltage at the sensor area which can then be detected for example with a simple potentiometer or bridge circuit (higher measuring accuracy).

An inductive sensor area is based on electromagnetic induction, the attenuation or change in frequency of a resonant circuit or respectively coil integrated into one of the two gripper jaws of the gripping tongs.

A magnetic field sensor area is based on magnetic field effects in hard or soft magnetic materials, semiconductors, ultra-thin layers, optical fibers, liquids or their surfaces. These effects in particular include galvanomagnetic effects (Hall effect) and magnetoresistive (MR) effects.

The effect of a capacitive sensor area formed in one of the gripper jaws is based on the capacitance change of a capacitor formed by the two gripper jaws.

Forming the first and/or second gripper jaw with a piezoelectric sensor area enables this sensor area to be realized—based on the piezoelectric effect—as a force transducer, pressure sensor or accelerometer.

According to a further aspect of the present invention, the gripping tongs comprise a synchronizing element. The synchronizing element is designed such that the first gripper jaw and the second gripper jaw can close in self-centering manner with respect to a central longitudinal axis of the gripping tongs. The central longitudinal axis of the gripping tongs thereby extends laterally centered between the first gripper jaw and the second gripper jaw within the gripping area of the gripping tongs.

This thereby achieves the self-centering closing of the gripper jaws when the gripping tongs close.

This type of synchronizing element in particular enables workpieces which are to be gripped not needing to be gripped precisely centrically along the central longitudinal axis of the gripping tongs but instead also being able to be gripped when offset from the central longitudinal axis of the gripping tongs. The force exerted on such a workpiece (object to be gripped) is in this case asymmetrical. It is nevertheless ensured that the gripper jaws will not thereby shift out of alignment with each other.

According to one conceivable realization, the synchronizing element comprises a circular cylindrical member which is arranged along a longitudinal axis parallel to the axes of rotation of the gripper jaws. Such a circular cylindrical member thus enables the gripper jaws to be able to be symmetrically closed with respect to the central longitudinal axis of the gripping tongs.

The circular cylindrical member is preferably arranged so as to vertically intersect the central longitudinal axis of the gripping tongs. This can thereby achieve self-centering and at the same time realize a compact gripping tongs structure.

A further realization of the inventive gripping tongs provides for the forming of a metallic, preferably magnetic or magnetizable area in the first gripper jaw. On the other hand, a sensor area is integrally formed in the second gripper jaw opposite from said metallic area, whereby this sensor area is designed to emit a signal, preferably an electrical signal, when the metallic area of the first gripper jaw contacts the sensor area of the second gripper jaw or falls short of a certain predefined or predefinable distance from the sensor area.

This thereby advantageously enables the detecting of a workpiece (object to be gripped) being gripped when the first gripper jaw and the second gripper jaw make contact with the workpiece (object to be gripped). The metallic area is thereby designed such that it makes contact with the sensor area precisely as the first jaw comes into contact.

The sensor area is preferably designed to be operated in a binary mode. That means that the sensor area does not emit any signal when it is not in contact with the metallic area of the first sensor jaw and does emit a signal when it is contact with the metallic area of the first gripper jaw. This can thereby ensure that the sensor area will only be triggered when an object to be gripped has been grasped.

According to a further aspect of the present invention, a control unit is allocated to the gripping tongs. The control unit is designed to determine a gripping by the gripping tongs when a signal is transmitted to the control unit from the first and/or second gripper jaw designed as a sensor. The first and/or second gripper jaw designed as a sensor is thereby preferably connected to the control unit. The control unit is preferably designed to evenly maintain the force exerted by the gripper jaws when the gripping of a workpiece by the gripping tongs is detected.

Thereby advantageously achievable, for example for the further processing or for the further operating of the gripping tongs, is the detecting of whether a workpiece has been grasped. Additionally able to be ensured is that the work-piece is not damaged by the gripping tongs.

The inventive solution is particularly suitable for miniature gripping tongs in which, due to the small size of the gripper jaws, it is not possible to attach a sensor device as known from the past prior art to one of the gripper jaws from the outside.

The inventive solution however also offers the further advantage of being able to reduce the weight of the gripper jaws due to the gripper jaws themselves being designed as a sensor device, which is in turn coupled with advantageous opening and closing speed of the gripping tongs.

One preferential realization of the inventive gripping tongs provides for the two gripper jaws to be of mirror-symmetrical design with respect to a central longitudinal axis of the gripping tongs. It is hereby particularly conceivable for the gripper jaws to be adapted to the contour of the object (workpiece/object to be gripped) and afford for example a large contact surface or even a positive connection of gripper jaw and object, whereby under certain circumstances, the gripping force can be kept low, which is advantageous when gripping easily breakable objects.

In preferential further developments of the inventive solution, a preferably pneumatically operable linear drive is configured in the housing of the gripping tongs via which a pivoting motion or a linear motion of the gripper jaws relative to each other can be realized. The linear drive comprises a working area able to be subjected to a preferably pneumatic means of pressure and a movable piston which is displaceable within the working area subject to the pressure means, wherein the piston is or can be coupled to the first and the second gripper jaw.

Alternatively thereto, it is also conceivable for the linear drive to comprise a working area able to be subjected to a preferably pneumatic means of pressure which is of at least partially elastic design such that the working area expands at least in the longitudinal direction of the gripping tongs subject to the pressure means. This working area expansion in the longitudinal direction of the gripping tongs when the working area is subjected to the means of pressure constitutes a linear motion which is preferably induced in both gripper jaws.

However, the inventive solution is by no means limited to pneumatically operated gripping tongs. In fact, hydraulic or electrical linear drives are certainly also conceivable.

Nor is the invention limited to gripping tongs in which the gripper jaws are pivoted relative to each other. On the contrary, the present invention is to also cover gripping tongs in which the gripper jaws displace or can displace linearly to one another.

What is claimed is:

1. Gripping tongs comprising:
a housing in which a pneumatically operable linear drive is formed; and
a first and a second gripper jaw, which are each pivotably mounted about an axis of rotation relative to the housing,
wherein at least one of the two gripper jaws is designed as a sensor and serves to emit a corresponding signal when the gripper jaws have gripped a workpiece and/or when the gripping tongs are in their closed state.

2. The gripping tongs according to claim 1,
wherein a resonating electrical circuit with a coil is integrated into the first gripper jaw, and
wherein the resonating electrical circuit is designed to vibrate when a supply voltage is applied and generate an electromagnetic field.

3. The gripping tongs according to claim 2,
wherein the resonating electrical circuit comprises a ferrite core in which the coil is situated in order to direct the electromagnetic field to a gripping area between the first and the second gripper jaw.

4. The gripping tongs according to claim 2,
wherein at least part of the second gripper jaw is formed from an electrically conductive material.

5. The gripping tongs according to claim 4, wherein the electrically conductive material is metallic material.

6. The gripping tongs according to claim 4,
wherein the electrically conductive material is provided in an area of the second gripper jaw which adjoins the gripping area between the first and the second gripping jaw.

7. The gripping tongs according to claim 2,
wherein an evaluation unit is further provided which is designed to detect an influencing of the oscillator voltage and emit a signal based on that which is indicative of a position of the gripper jaws relative to each other.

8. The gripping tongs according to claim 1,
wherein the first gripper jaw is designed as a measuring electrode and the second gripper jaw is designed as a counter electrode which together form an electrical capacitor.

9. The gripping tongs according to claim 8,
wherein an evaluation unit is further provided which is designed to detect an influencing of the electrical field in the gripping area between the first and the second gripper jaw and emit a signal based on that which is indicative of a position of the gripper jaws relative to each other and/or indicative of a workpiece gripped between the gripper jaws.

10. The gripping tongs according to claim 1,
wherein at least one area of the first and/or second gripper jaw is designed as a resistive sensor area, inductive sensor area, magnetic field sensor area, capacitive sensor area and/or piezoelectric sensor area.

11. The gripping tongs according to claim 1,
wherein a control unit is further provided which is designed to detect a gripping by the gripping tongs when a signal is transmitted to the control unit from the first and/or second gripper jaw designed as a sensor, and
wherein the control unit is designed to evenly maintain a force exerted by the gripper jaws when the gripping of a workpiece by the gripping tongs is detected.

12. The gripping tongs according to claim 1,
wherein the gripping tongs comprise a synchronizing element which is designed such that the first gripper jaw on the one hand and the second gripper jaw on the other can close in self-centering manner with respect to a central longitudinal axis of the gripping tongs which extends laterally centered between the first gripper jaw on the one hand and the second gripper jaw on the other.

13. The gripping tongs according to claim 12,
wherein the synchronizing element comprises a circular cylindrical member which is arranged along a longitudinal axis parallel to the axes of rotation of the gripper jaws.

14. The gripping tongs according to claim 1,
wherein the first gripper jaw and the second gripper jaw are of mirror-symmetrical design with respect to a central longitudinal axis of the gripping tongs.

15. The gripping tongs according to claim 1,
wherein a linear drive is configured in the housing of the gripping tongs which comprises a working area able to be subjected to a pneumatic means of pressure and a movable piston which is displaceable within the working area subject to the pressure means, wherein the piston is or can be coupled to the first gripper jaw and the second gripper jaw.

16. The gripping tongs according to claim 1,
wherein a linear drive is configured in the housing of the gripping tongs which comprises a working area able to be subjected to a pneumatic means of pressure which is of at least partially elastic design such that the working area expands in the longitudinal direction of the gripping tongs subject to the pressure means.

17. The gripping tongs according to claim 1,
wherein at least one restoring element is provided which interacts with at least one of the two gripper jaws such that the at least one gripper jaw is moved in its closing or opening direction when the linear drive is not introducing any linear force to the gripper jaws.
